(19) United States
(12) Patent Application Publication
(10) Pub. No.: US 2024/0214304 A1
(43) Pub. Date: Jun. 27, 2024

(54) COMMUNICATION INTERFACE AND METHOD FOR SEAMLESS DATA COMMUNICATION OVER MULTILANE COMMUNICATION LINK

(71) Applicant: HUAWEI TECHNOLOGIES CO., LTD., Shenzhen (CN)

(72) Inventors: Sujan Pandey, Leuven (BE); Yumeng Yang, Nanjing (CN)

(21) Appl. No.: 18/598,914

(22) Filed: Mar. 7, 2024

Related U.S. Application Data
(63) Continuation of application No. PCT/CN2021/117006, filed on Sep. 7, 2021.

(51) Int. Cl. H04L 45/24; H04L 12/40

(52) U.S. Cl. CPC H04L 45/24; H04L 12/4013; H04L 2012/40273

(57) ABSTRACT

A communication interface for use at a first end of a communication link including a number of communication lanes greater or equal to two. The communication interface includes a logic configured to cooperate with another communication interface at a second end of the communication link to send a data frame to the second end over the communication lanes. The logic is configured to store a communication lane status for each of the communication lanes, and when detecting that the communication lane status for a specific communication lane has changed to a determined status. The logic is configured to send the changed communication lane status for the specific communication lane to the communication interface at the second end and split a data frame accordingly. The communication interface provides seamless data communication between the first end and the second end of the communication link, even in case of a lane failure.

### CROSS-REFERENCE TO RELATED APPLICATIONS

This application is a continuation of International Application No. PCT/CN2021/117006, filed on Sep. 7, 2021, the disclosure of which is hereby incorporated by reference in its entirety.

### TECHNICAL FIELD

The present disclosure relates generally to the field of data communication; and, more specifically, to a communication interface for use at both ends of a communication link, a communication network including the communication interface, and a method of seamless data communication over a multilane communication link.

### BACKGROUND

Generally, autonomous vehicles require a high-speed (e.g., multi-gigabit) data communication link in order to transfer data from various sensors (e.g., camera1, camera2, RADAR, and the like) to a central processing unit (CPU). Typically, an in-vehicle communication network is used to communicate data among various sensors (or nodes) and from the sensors to the CPU. Conventionally, a high-speed automotive Ethernet standard is used for the multi-gigabit data communication among the sensors as well as from the sensors to the CPU. The conventional high-speed automotive Ethernet standard employs a single twisted pair cable. However, the single twisted pair cable has its own physical limit with respect to bandwidth. By virtue of the physical limit of the single twisted pair cable, the single twisted pair cable is not preferably used for the multi-gigabit data communication. The multi-gigabit data communication deals with a high data rate that is beyond 25 Gbit per second (Gbit/s). Therefore, there is a requirement for multilane technology that can deliver multiples of gigabit as a backbone for communication with the autonomous vehicles. In the autonomous vehicles, the multilane technology (or the multi-gigabit communication technology) is related to safety. If anyone lane of the multilane technology is broken then, the entire communication link will stop working. Moreover, the lane failure may further result in undesirable consequences. In the typical in-vehicle communication network, multiple cables are used in order to connect various sensors with each other as well as to the CPU. The use of multiple cables results in cable congestion; also, the cables contribute quite some portion of the total weight of the typical autonomous vehicle. Therefore, in order to reduce cable congestion, multiple sensors are aggregated in a typical switch. A multi-gigabit communication link is established between various typical switches, which acts as a backbone of the typical in-vehicle network communication. In a case, if anyone lane of the multi-gigabit communication link is turned into a failure, then, in such a case, there will be no communication at all.

Currently, certain attempts have been made in order to maintain the communication between various typical switches in case of a lane failure, such as a conventional method is based on using huge buffers on a physical (PHY) layer(s). However, the conventional method results in an additional latency to the overall communication. Furthermore, the conventional method describes that the coding is done and the received data is aligned at the receiver, but the method does not provide any detail on how the coding is done without affecting the hardware and performance. Thus, there exists a technical problem of a communication link drop in case of any lane failure, resulting in no communication or a flawed and unreliable communication between various typical switches of the typical in-vehicle communication network.

Therefore, in light of the foregoing discussion, there exists a need to overcome the aforementioned drawbacks associated with the conventional methods of maintaining the communication between various typical switches in case of a lane failure of the multilane technology.

### SUMMARY

The present disclosure provides a communication interface for use at both ends of a communication link. The present disclosure further provides a communication network with the communication interface and a method of seamless data communication over a multilane communication link. The present disclosure provides a solution to the existing problem of a communication link drop in case of any lane failure, resulting in no communication or a flawed and unreliable communication between various typical switches of a typical in-vehicle network. An aim of the present disclosure is to provide a solution that overcomes at least partially the problems encountered in the prior art, and provides an improved communication interface that provides seamless data communication at both ends of a communication link, even in case of a lane failure. The present disclosure further provides a communication network with an improved communication interface that manifests flawless and reliable communication, even in case of a lane failure and a method of seamless data communication over a multilane communication link.

One or more objects of the present disclosure are achieved by the solutions provided in the enclosed independent claims. Advantageous implementations of the present disclosure are further defined in the dependent claims.

In an aspect, the present disclosure provides a communication interface for use at a first end of a communication link comprising a number of communication lanes greater or equal to two. The communication interface comprises a logic configured to cooperate with another communication interface at a second end of the communication link to send a data frame to the second end over the communication lanes, where sending a data frame includes splitting the data frame into a number of subframes corresponding to the number of communication lanes and sending each of the subframes over one distinct communication lane amongst said communication lanes. The logic is further configured to store a communication lane status for each of the communication lanes, and when detecting that the communication lane status for a specific communication lane has changed to a determined status, the logic is further configured to stop sending subframes over the specific communication lane. The logic is further configured to send the changed communication lane status for the specific communication lane to the communication interface at the second end and split any data frame into a number of subframes corresponding to the number of communication lanes with a communication status which is not the determined status, and send each of the subframes over one distinct communication lane amongst the communication lanes with a communication status which is not the determined status.

The disclosed communication interface provides seamless data communication between the first end and the second end of the communication link, even in case of a lane failure. Additionally, the logic at the communication interface is configured to periodically communicate the communication lane status of the number of communication lanes to each of the communication interface at the first end and the other communication interface at the second end of the communication link. If any fault is detected in any one lane of the number of communication lanes, the logic immediately communicates the lane failure to each of the communication interface at the first end and the other communication interface at the second end and stop sending the number of subframes of the data frame over the faulty lane. Moreover, the logic is configured to shut down the gate and buffer corresponding to the faulty lane and maintains the communication between both ends of the communication link through the remaining communication lanes, which are active at that time. Thus, each of the communication interface at the first end and the other communication interface at the second end manifests safety regarding the lane failure as well as provides seamless data communication between both ends of the communication link. However, the data is communicated at a partially reduced speed.

In an implementation form, the logic is further configured to cooperate with the communication interface at the second end of the communication link to receive a data frame from the second end over the communication lanes. A received data frame being split into a number of received subframes corresponding to the number of communication lanes, where receiving the data frame includes receiving each of the subframes over one distinct communication lane amongst said communication lanes and merging the received subframes into a received data frame, and where the logic is further configured to receive the determined status as the communication lane status of a given communication lane from the communication interface at the second end, and store the received determined status as the status of the given communication lane. The logic is further configured to stop receiving subframes over the given communication lane and merge the subframes received over the communication lanes with a communication status which is not the determined status, into the received data frame.

The communication interface at the first end is configured to transmit as well as receiving a data frame from the other communication interface at the second end. Similarly, the other communication interface at the second end is configured to receive as well as transmit a data frame to the communication interface at the first end. Thus, full-duplex communication is maintained between each of the communication interface at the first end and the other communication interface at the second end.

In a further implementation form, the communication interface further comprises for each communication lane, a buffer configured to receive a subframe to be transmitted, over the said communication lane, to a corresponding buffer in the communication interface at the second end, and a gate configured to open or close the input in the buffer of a subframe to be transmitted over the said communication lane, to the corresponding buffer in the communication interface at the second end, the logic being configured to control the gate depending on the communication lane status of said communication lane.

By virtue of using the buffer and the gate corresponding to each communication lane, reliable and high-speed data communication is obtained between both ends of the communication link.

In a further implementation form, the buffer is configured to receive a subframe transmitted over the communication lane from the corresponding buffer in the communication interface at the second end, and the gate is configured to open or close the output of a subframe received over the said communication lane, the logic being configured to control the gate depending on the communication lane status of said communication lane.

In another aspect, the present disclosure provides a communication network comprising a first node at a first end of a communication link and a second node at a second end of the communication link. The communication link comprises a number of communication lanes greater or equal to two, the first and the second nodes each comprises the communication interface.

The communication network provides seamless data communication between the first node and the second node, even in case of a lane failure of the number of the lanes of the communication link between the first node and the second node. The seamless data communication is obtained by virtue of comprising the disclosed communication interface at each of the first node and the second node.

In an implementation form, the communication network is an in-vehicle communication network.

The in-vehicle communication network manifests multi-gigabit communication as well as seamless data communication in spite of a lane failure.

In yet another aspect, the present disclosure provides a method of communication over a communication link comprising a number of communication lanes greater or equal to two and having a first end and a second end. The method comprises sending a data frame from the first end to second end over the communication lanes, where sending a data frame includes splitting the data frame into a number of subframes corresponding to the number of communication lanes and sending each of the subframes over one distinct communication lane amongst said communication lanes. The method further comprises storing, at the first end, a communication lane status for each of the communication lanes and detecting, at the first end, that the communication lane status for a specific communication lane has changed to a determined status, and when detecting, at the first end, that the communication lane status for the specific communication lane has changed to the determined status. The method further comprises stop sending subframes from the first end to the second end over the specific communication lane and sending the changed communication lane status for the specific communication lane, from the first end to the second end. The method further comprises at the first end, splitting any data frame into a number of subframes corresponding to the number of communication lanes with a communication status which is not the determined status, and sending to the second end each of the subframes over one distinct communication lane amongst the communication lanes with a communication status which is not the determined status.

The disclosed method achieves all the advantages and technical features of the communication interface of the present disclosure.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application, as well as the functionalities described to be performed by the various entities, are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a network environment that illustrates seamless data communication between a first node placed at a first end of a communication link and a second node placed at a second end of the communication link, in accordance with an embodiment of the present disclosure;

FIG. 2 illustrates communication between various sub-blocks associated with communication interfaces of a first node and a second node, in accordance with an embodiment of the present disclosure;

FIG. 3 illustrates communication between a first end and a second end of a communication link with a lane being faulty, in accordance with an embodiment of the present disclosure;

FIG. 4A illustrates merging of a number of communication lanes without a failure scenario, in accordance with an embodiment of the present disclosure;

FIG. 4B illustrates merging of a number of communication lanes without a failure scenario, in accordance with another embodiment of the present disclosure;

FIG. 4C illustrates an internal circuitry of a physical layer of 100 Gbit/s, in accordance with an embodiment of the present disclosure; and

FIGS. 5A and 5B collectively is a flowchart of a method of communication over a communication link comprising a number of communication lanes, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

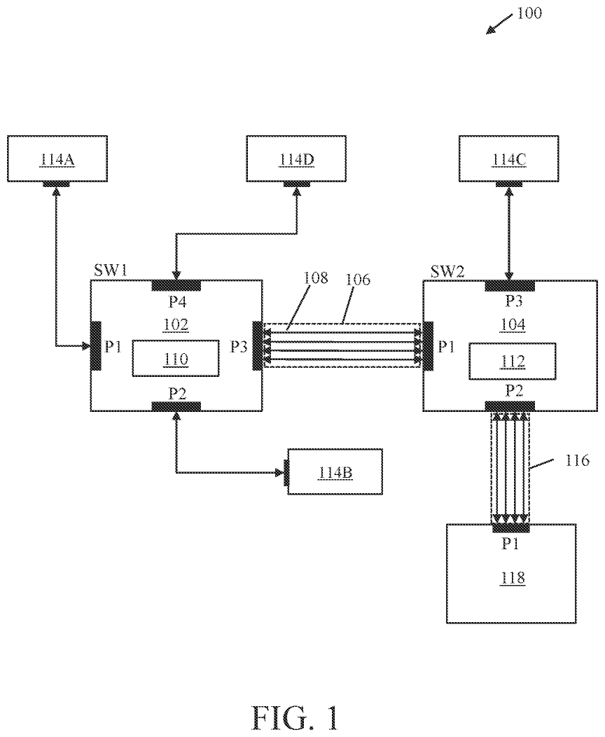

FIG. 1 is a network environment that illustrates seamless data communication between a first node placed at a first end of a communication link and a second node placed at a second end of the communication link, in accordance with an embodiment of the present disclosure. With reference to FIG. 1, there is shown a communication network 100 that includes a first node 102 and a second node 104. The first node 102 is located at a first end of a communication link 106 and the second node 104 is located at a second end of the communication link 106. The communication link 106 includes a number of communication lanes 108 which is either greater or equal to two in number. The first node 102 and the second node 104 includes a communication interface 110 and another communication interface 112, respectively. There is further shown a plurality of sensors, such as a first sensor 114A, a second sensor 114B, a third sensor 114C and a fourth sensor 114D, connected to the first node 102 and the second node 104. Furthermore, there is a communication link 116 between the second node 104 and an electronic control unit 118.

The communication network 100 provides a seamless data communication between the first node 102 and the second node 104. The communication network 100 maintains the communication between the first node 102 and the second node 104, even in case of a lane failure of the number of the communication lanes 108 of the communication link 106. Conventionally, if anyone lane of the number of lanes is turned into a failure, then there was no communication among typical nodes of a typical communication network. In spite of the lane failure, the communication network 100 provides communication between the first node 102 and the second node 104 at a partially reduced data rate. In an implementation, the communication network 100 is an in-vehicle communication network. Being the in-vehicle communication network, the communication network 100 includes a medium (either wired or wireless or optical) through which the various control units or components, such as the first node 102 with the communication interface 110, the second node 104 with the other communication interface 112, the plurality of sensors, the electronic control unit 118 communicate with each other. Examples of the wired and wireless communication protocols for the communication network 100 may include, but are not limited to, a vehicle area network (VAN), a CAN bus, Domestic Digital Bus (D2B), Time-Triggered Protocol (TTP), FlexRay, IEEE 1394, Inter-Integrated Circuit (I2C), Inter Equipment Bus (IEBus), Society of Automotive Engineers (SAE) J1708, SAE J1939, International Organization for Standardization (ISO) 11992, ISO 11783, Media Oriented Systems Transport (MOST), MOST25, MOST50, MOST150, Plastic optical fibre (POF), Power-line communication (PLC), Serial Peripheral Interface (SPI) bus, and/or Local Interconnect Network (LIN).

Each of the first node 102 and the second node 104 corresponds to a switch. For example, the first node 102 may also be referred to as a first switch (also represented as SW1), and the second node 104 may also be referred to as a second switch (also represented as SW2). Other examples of the first node 102 and the second node 104 may include, but are not limited to, a local area network switch (LAN-SW), a router, a transmitter, a receiver, a transmitting device, a receiving device, a transceiver, and the like.

Each of the first node 102 and the second node 104 are located at the first end and the second end of the communication link 106, respectively. The communication link 106 is a full-duplex link. This means that each of the first node 102 and the second node 104 can be configured for simultaneously transmitting and receiving data over the communication link 106. Moreover, the communication link 106 between the first node 102 and the second node 104 can be either wired or wireless, or optical in nature, depending on a use case. The communication link 106 between the first node 102 and the second node 104 is a multilane communication link; hence, the communication link 106 can provide a data rate of either 25 Gbit/s, 50 Gbit/s, 100 Gbit/s, or beyond 100 Gbit/s. In the communication network 100, the communication link 106 includes four communication lanes 108. Therefore, the communication network 100 provides a data rate of 100 Gbit/s over the communication link 106. However, in another implementation, the number of communication lanes 108 may range up to N number of lanes. Examples of the communication link 106 may include, but are not limited to, a Wireless Fidelity (Wi-Fi) communication link, a Local Area Network (LAN) communication link, a wireless personal area network (WPAN) communication link, a Wireless Local Area Network (WLAN) communication link, a wireless wide area network (WWAN) communication link, a cloud network communication link, a Long-Term Evolution (LTE) network communication link, a Metropolitan Area Network (MAN) communication link, and/or the Internet.

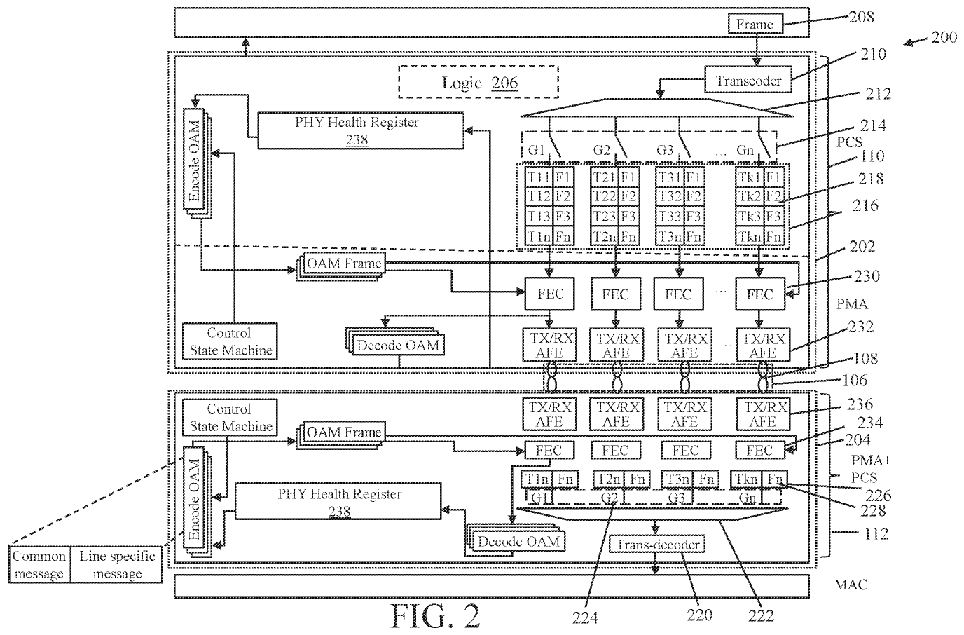

The first node 102 and the second node 104 include the communication interface 110 and the other communication interface 112, respectively. The communication interface 110 at the first node 102 is configured to cooperate with the other communication interface 112 at the second node 104 in order to send a data frame over the communication link 106, described in detail, for example, in FIG. 2. Examples of each of the communication interface 110 and the other communication interface 112 may include, but are not limited to, an antenna, a telematics unit, a radio frequency (RF) transceiver, one or more amplifiers, one or more oscillators, a digital signal processor, a coder-decoder (CODEC) chipset, and/or a subscriber identity module (SIM) card.

In the communication network 100, each of the first sensor 114A, the second sensor 114B, and the fourth sensor 114D is connected to the first node 102, and the third sensor 114C is connected to the second node 104. Each of the first sensor 114A, the second sensor 114B, the third sensor 114C, and the fourth sensor 114D is connected at physical layer(s) of the first node 102 and the second node 104. For example, each of the first sensor 114A, the second sensor 114B, and the fourth sensor 114D is connected at physical layers (represented by P1, P2 and P4, respectively) of the first node 102 and each connection provides a data rate of 25 Gbit/s. Similarly, the third sensor 114C is connected at physical layer (also represented by P3) of the second node 104 and provides a data rate of 25 Gbit/s. The first node 102 and the second node 104 are connected with each other through the communication link 106 between physical layers (P3, P1) of the first node 102 and the second node 104, respectively. Examples of each of the first sensor 114A, the second sensor 114B, the third sensor 114C, and the fourth sensor 114D may include, but are not limited to, camera1, camera2, radio detection and ranging (RADAR), light detection, and ranging (LiDAR), global navigation satellite system (GNSS) receiver, dash-cam, and the like.

The communication link 116 between the second node 104 and the electronic control unit 118 corresponds to the communication link 106 between the first node 102 and the second node 104. The electronic control unit 118 includes suitable logic, circuitry, interfaces, and/or code that is configured to monitor and optimize the performance of the plurality of sensors depending on the data received from the first node 102 and the second node 104.

FIG. 2 illustrates communication between various sub-blocks associated with communication interfaces of a first node and a second node, in accordance with an embodiment of the present disclosure. FIG. 2 is described in conjunction with elements from FIG. 1. With reference to FIG. 2, there is shown a circuit architecture 200 that illustrates communication between various sub-blocks associated with the communication interface 110 of the first node 102 and the other communication interface 112 of the second node 104 of the communication network 100 (of FIG. 1). The circuit architecture 200 illustrates that the communication interface 110 is configured for use at a first end 202 of the communication link 106, and the other communication interface 112 is configured for use at a second end 204 of the communication link 106. The communication interface 110 comprises a logic 206. There is further shown a data frame 208 received from a medium access control (MAC) layer. Each of the first end 202 and the second end 204 of the communication link 106, and the logic 206 of the communication interface 110 is represented by a dashed box, which is used for illustration purposes only and does not form a part of the circuitry.

Each of the communication interface 110 and the other communication interface 112 includes a physical coding sublayer (PCS) and physical medium attachment (PMA). The PCS at the communication interface 110 includes a transcoder 210, a demultiplexer 212 with a number of gates 214, a number of buffers 216, and a pipe data representing a number of subframes 218. Similarly, the PCS at the other communication interface 112 includes a trans-decoder 220, a multiplexer 222 with a number of gates 224, a number of buffers 226, and a pipe data representing a number of subframes 228. The PMA at the communication interface 110 includes forward error correction (FEC) comprising FEC encoders (FEC-EN) and FEC decoders (FEC-DEC) 230 and transmitter-receiver analog front end (TX/RX-AFE) 232, one for each communication lane. Similarly, the PMA at the other communication interface 112 includes forward error correction (FEC) comprising FEC encoders (FEC-EN) and FEC decoders (FEC-DEC) 234 and transmitter-receiver analog front end (TX/RX-AFE) 236, one for each communication lane. There is further shown a physical health register 238, which is accessible to both the PCS and PMA of each of the communication interface 110 and the other communication interface 112. Each of the number of gates 214, the number of buffers 216 at the PCS of the communication interface 110, and the number of gates 224 at the PCS of the other communication interface 112 is represented by a dashed box, which is used for illustration purposes only and does not form a part of the circuitry.

The present disclosure provides the communication interface 110 for use at the first end 202 of the communication link 106 comprising the number of communication lanes 108 greater or equal to two. The communication interface 110 comprises the logic 206 configured to cooperate with the other communication interface 112 at the second end 204 of the communication link 106 to send the data frame 208 to the second end 204 over the communication lanes 108, where sending the data frame 208 includes splitting the data frame into the number of subframes 218 corresponding to the number of communication lanes 108 and sending each of the subframes 218 over one distinct communication lane amongst said communication lanes 108. The communication interface 110 of the first node 102 (of FIG. 1) is configured for use at the first end 202 of the communication link 106. The communication link 106 comprises the number of communication lanes 108 which ranges up to N number of communication lanes. Therefore, the communication link 106 is referred to as a multilane communication link. Furthermore, the logic 206 at the communication interface 110 is configured to cooperate with the other communication interface 112 of the second node 104 (of FIG. 1) at the second end 204 of the communication link 106 to send the data frame 208 received from the MAC layer to the second end 204 over the number of communication lanes 108. Before sending the data frame 208 to the second end 204 of the communication link 106, the data frame 208 is split into the number of subframes 218 corresponding to the number of communication lanes 108. For example, if the number of communication lanes 108 is N, then the data frame 208 is split into N number of sub-frames, and each sub-frame is transmitted through one distinct communication lane among the number of communication lanes 108.

Examples of the logic 206 may include, but are not limited to, a microcontroller, a microprocessor, a central processing unit (CPU), a complex instruction set computing (CISC) processor, an application-specific integrated circuit (ASIC) processor, a reduced instruction set (RISC) processor, a very long instruction word (VLIW) processor, a data processing unit, and other processors or control circuitry.

In accordance with an embodiment, the communication interface 110 further comprises for each communication lane, a buffer configured to receive a subframe to be transmitted, over the said communication lane, to a corresponding buffer in the communication interface 112 at the second end 204, and a gate configured to open or close the input in the buffer of a subframe to be transmitted over the said communication lane, to the corresponding buffer in the communication interface 112 at the second end 204, the logic 206 is configured to control the gate depending on the communication lane status of said communication lane. After dividing the data frame 208 into the number of subframes 218, each subframe is passed to the buffer comprised by the communication interface 110. The buffer corresponds to one among the number of buffers 216. The number of buffers 216 are proportional to the number of communication lanes 108. Each buffer of the number of buffers 216 is configured to transmit the received subframe over one communication lane to the corresponding buffer comprised by the communication interface 112 at the second end 204 of the communication link 106. In addition to the number of buffers 216, the communication interface 110 comprises the number of gates 214. Each of the number of gates 214 is configured to open or close the input in the buffer of the subframe, which is to be transmitted over one communication lane of the number of communication lanes 108. The subframe is transmitted to the corresponding buffer in the communication interface 112 at the second end 204 of the communication link 106. The logic 206 at the communication interface 110 is configured to control each of the number of gates 214 depending on the working status of the number of communication lanes 108.

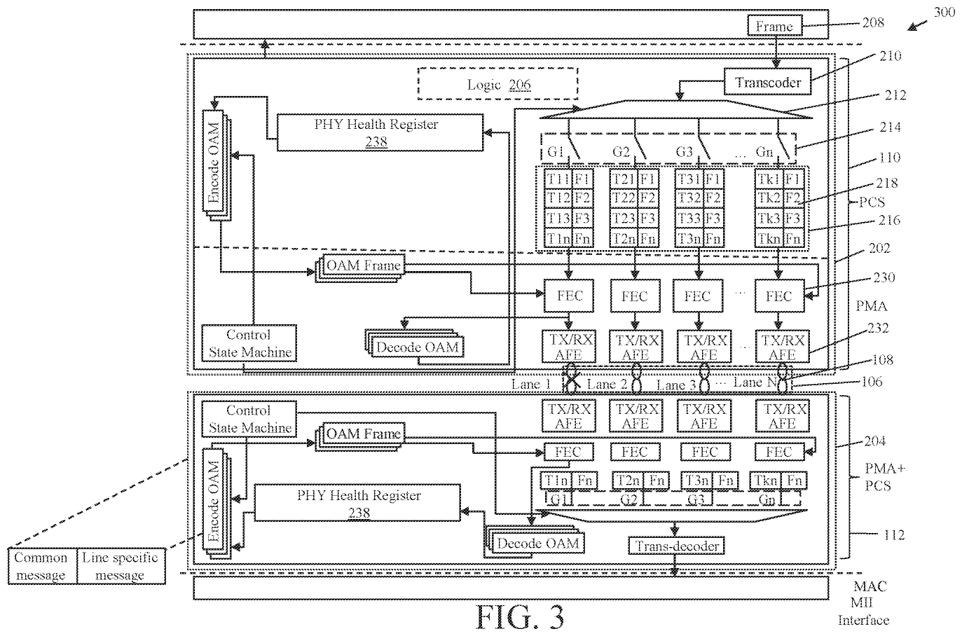

The logic 206 is further configured to store a communication lane status for each of the communication lanes 108 and when detecting that the communication lane status for a specific communication lane has changed to a determined status. The logic 206 is further configured to stop sending subframes over the specific communication lane and send the changed communication lane status for the specific communication lane to the communication interface 112 at the second end 204. The logic 206 is further configured to split any data frame into a number of subframes corresponding to the number of communication lanes with a communication status which is not the determined status, and send each of the subframes over one distinct communication lane amongst the communication lanes with a communication status which is not the determined status. The logic 206 is configured to store the communication lane status for each of the number of communication lanes 108 in the communication link 106. For example, in a case when it is detected that the communication lane status for the specific communication lane (e.g., lane 1) has changed to the determined status (or faulty status). In that case, the logic 206 is further configured to stop sending the subframes over that specific communication lane (i.e., lane 1). The logic 206 is further configured to communicate the changed communication lane status (i.e., faulty) of the specific communication lane (i.e., lane 1) to the other communication interface 112 at the second end 204 of the communication link 106. Therefore, in case of failure of the specific communication lane (i.e., lane 1), the number of communication lanes 108 available for transmitting the subframes to the other communication interface 112 reduces and resulting in a reduced data rate. Moreover, the logic 206 is further configured to split the data frame into the number of subframes corresponding to the number of communication lanes 108, which are active at that time. The logic 206 is further configured to send each of the subframes over one distinct communication lane among the number of communication lanes 108 which are active at that time. In this way, in spite of the failure of the specific communication lane (i.e., lane 1), the logic 206 at the communication interface 110 maintains seamless data communication between the communication interface 110 at the first end 202 and the other communication interface 112 at the second end 204 of the communication link 106. An exemplary scenario of seamless data communication with a faulty communication lane is described in detail, for example, in FIG. 3.

In operation, at the communication interface 110, the transcoder 210 is configured to add first few bits for control purpose in the data frame 208 received from the MAC layer. The data frame 208 is a fixed size data frame. Depending on the number of communication lanes 108 which are active at a time, the output of the transcoder 210 is chopped by use of the demultiplexer 212 into an equal number of subframes that is proportional to the number of gates 214 (also represented as G₁, G₂, G₃, . . . , Gₙ). For example, if the number of gates 214 functioning at a time is four then, the number of subframes 218 will also be equal to four. One subframe of the number of subframes 218, when enters to a buffer of the number of buffers 216 will be encoded by an index Tₖₙ, where k refers to the gate ID that allows the subframe to enter to the buffer and n refers to the frame ID. The data frame 208 is an integer and may reset and repeat after overflow. The logic 206 (e.g., a controller) is configured to open the number of gates 214 starting from a first gate (or G₁), after then, the logic 206 moves to open a second gate (G₂) and so on. For example, a first transcoder block (also represented as T11, T12, T13, . . . , T1n with the number of subframes as F1, F2, F3, . . . , Fn) passes via the first gate (i.e., G₁) and a second transcoder block (also represented as T21, T22, T23, . . . , T2n with the number of subframes as F1, F2, F3, . . . , Fn) passes via the second gate (i.e., G₂) and so on. Once each buffer of the number of buffers 216 is filled with data, then, the data moves to forward error correction (FEC) at PMA of the communication interface 110 at the first end 202 of the communication link 106. The size of each of the number of buffers 216 is equal to FEC frame input. The FEC includes both FEC encoding and FEC decoding by use of FEC encoders (FEC-EN) and FEC decoders (FEC-DEC), respectively. There is further shown an Operation, Administration, and Management (OAM) frame input to the FEC-EN 230, which means that the OAM is being glued to the FEC frame during encoding of the FEC frame at the communication interface 110. Therefore, the FEC-EN 230 encodes each subframe of the number of subframes 218 along with the OAM message into its frame. After FEC encoding, the encoded bits are mapped into symbols as a part of line coding and transmitted to the other communication interface 112 at the second end 204 of the communication link 106 by use of the transmitter analog front end (TX-AFE) 232. At the communication interface 110 within the PCS block, there is further shown an encode OAM message which comprises two types of messages namely, a common message that is common to all lanes and a lane-specific message that is specific to a lane only.

In the circuit architecture 200, the communication between the communication interface 110 and the other communication interface 112 is symmetrical and bidirectional data communication, hence, this communication is also termed as a full-duplex communication. Moreover, the circuit architecture 200, illustrates various link partners of the communication link 106 and their associated sub blocks within the physical layer for communication between the first node 102 and the second node 104 (of FIG. 1) to facilitate a high data rate. The communication between the first node 102 and the second node 104 is symmetrical bidirectional communication, therefore, all links are enabled at both ends of the communication link 106. In order to facilitate symmetrical bidirectional data communication, each of the communication interface 110 and the other communication interface 112 is configured to function as a transmitter as well as a receiver or better to say as a transceiver. Therefore, in the circuit architecture 200, each of the communication interface 110 and the other communication interface 112 is configured to function as a transceiver. Hence, the communication interface 110 (or a transceiver) is able to transmit the data frame 208 by splitting the data frame 208 to the number of subframes 218 to the other communication interface 112 as well as receive a number of subframes of a data frame from the other communication interface 112 and further merge the number of subframes by its own. In another implementation, the communication interface 110 (or a transmitter) can be configured to transmit a data frame to the other communication interface 112 (or a receiver) which is configured to receive a number of subframes of the data frame and merge them together in order to obtain the data frame.

In accordance with an embodiment, the logic 206 is further configured to cooperate with the communication interface 112 at the second end 204 of the communication link 106 to receive a data frame from the second end 204 over the communication lanes 108. A received data frame being split into a number of received subframes corresponding to the number of communication lanes 108, where receiving the data frame includes receiving each of the subframes over one distinct communication lane amongst said communication lanes and merging the received subframes into a received data frame, and where the logic 206 is further configured to receive the determined status as the communication lane status of a given communication lane from the communication interface 112 at the second end 204, and store the received determined status as the status of the given communication lane. The logic 206 is further configured to stop receiving subframes over the given communication lane and merge the subframes received over the communication lanes with a communication status which is not the determined status, into the received data frame. In an implementation, the communication interface 110 at the first end 202 is configured to function as a receiver and the other communication interface 112 at the second end 204 is configured to function as a transmitter. In such implementation, the communication interface 110 is configured to receive the data frame from the other communication interface 112 at the second end 204 of the communication link 106. The received data frame is split into the number of received subframes (e.g., F1, F2, F3, . . . , Fn) which are proportional to the number of communication lanes 108. The number of received subframes are processed by the RX-AFE 232 and then, FEC decoded by the use of FEC-DEC 230 of the communication interface 110. After FEC decoding, the FEC data and OAM message are separated and the OAM message goes to decode OAM block. The message bits from the decode OAM block are stored at their corresponding space in a memory or a register, for example, the physical health register 238. The physical health register 238 is configured to store local and remote physical layers (e.g., the physical layers of the first end 202 as well as the second end 204 of the communication link 106), status (e.g., signal-to-noise-ratio, SNR, bit error rate, BER) of the communication link 106, cable health (e.g., open or short), FEC errors and scrambler and identity of the number of communication lanes 108 which are functional at a time. The FEC decoded data goes to each buffer corresponding to a specific communication lane and later passed to the transcoder 210 (which may function as a trans decoder as well) to remove added control bits. Thereafter, the received data is passed to MAC via a MAC interface (e.g., MII interface). The order of opening the number of gates 214 will remain same as it was done at the time of transmission of the data frame 208. The relevant OAM messages are interpreted locally after decoding and stored in the physical health register 238. Further, if required, suitable actions will be taken based on the OAM message. In the process of receiving the number of subframes, each subframe is received over one distinct communication lane among the number of communication lanes 108. After receiving each subframe of the number of subframes from the second end 204, the number of received subframes are merged into the received data frame. In order to receive each subframe, the logic 206 is configured to receive the determined (i.e., faulty) status, if any, of the given communication lane from the other communication interface 112 at the second end 204. In case of the faulty communication lane, the logic 206 is further configured to stop receiving the subframes over the faulty communication lane and merge the subframes received over the healthy communication lanes in order to obtain the received data frame reliably.

In another implementation, the other communication interface 112 at the second end 204 can be configured to receive a data frame from the communication interface 110 at the first end 202 of the communication link 106. The received data frame being split into a number of subframes, the other communication interface 112 is configured to receive each subframe over one distinct communication lane among the number of communication lanes 108. The number of received subframes are processed by the RX-AFE 236 and then, FEC decoded by the use of FEC-DEC 234 of the other communication interface 112. After FEC decoding, the

FEC decoded data goes to each buffer of the number of buffers 226 corresponding to a specific communication lane and later passed to the trans decoder 220 to remove added control bits. Thereafter, the received data is passed to MAC via a MAC interface (e.g., a media-independent interface, MII). The order of opening the number of gates 224 will remain the same as it was done at the time of transmission of the data frame 208 at the communication interface 110. The relevant OAM messages are interpreted locally after decoding and stored in the physical health register 238. In this way, each of the communication interface 110 and the other communication interface 112 is configured to function as the transceiver.

In accordance with an embodiment, the buffer is configured to receive a subframe transmitted over the communication lane from the corresponding buffer in the communication interface 112 at the second end 204, and the gate is configured to open or close the output of a subframe received over the said communication lane, the logic 206 is configured to control the gate depending on the communication lane status of said communication lane. In an implementation, the communication interface 110 at the first end 202 is configured to function as a receiver and the other communication interface 112 at the second end 204 is configured to function as a transmitter. In such implementation, each buffer of the number of buffers 216 is configured to receive the subframe which is transmitted by the corresponding buffer in communication interface 112 at the second end 204 of the communication link 106. Consequently, each gate of the number of gates 214 is configured to open or close the output of the subframe received over the communication lane among the number of communication lanes 108. The logic 206 is further configured to control each of the number of gates 214 depending on the status (either functional or non-functional) status of the number of communication lanes 108.

Thus, the communication interface 110 provides seamless data communication between the first node 102 and the second node 104 of the communication network 100, even in case of a lane failure. Additionally, the logic 206 at the communication interface 110 is configured to periodically communicate the communication lane status of the number of communication lanes 108 to each of the communication interface 110 at the first end 202 and the other communication interface 112 at the second end 204 of the communication link 106. If any fault is detected in any one lane of the number of communication lanes 108, the logic 206 immediately communicates the lane failure to each of the communication interface 110 and the other communication interface 112 by use of the “common message” of the OAM message and stop sending (or receiving) the number of subframes 218 of the data frame 208 over the faulty lane. Moreover, the logic 206 is configured to shut down the gate and buffer corresponding to the faulty lane and maintains the communication between both ends of the communication link 106 through remaining communication lanes which are active at that time. Thus, the communication interface 110 manifests the safety regarding the lane failure as well as the seamless data communication between both ends of the communication link 106. However, the data is communicated at a partially reduced speed. Hence, the communication interface 110 can become a part of an institute of electrical and electronics engineers (IEEE) standard, which is currently being defined as IEEE 802.3cy for providing different data rates, such as 25 Gbps, 50 Gbps or 100 Gbps.

FIG. 3 illustrates seamless communication between a first end and a second end of a communication link with a lane being faulty, in accordance with an embodiment of the present disclosure. FIG. 3 is described in conjunction with elements from FIGS. 1 and 2. With reference to FIG. 3, there is shown a circuit architecture 300 that illustrates seamless communication between the first end 202 and the second end 204 of the communication link 106 comprising a faulty communication lane among the number of communication lanes 108.

The number of communication lanes 108 includes N number of communications lanes, such as lane 1, lane 2, lane 3, up to lane N. Initially, all the lanes (i.e., lane 1, lane 2, lane 3, . . . , lane N) among the number of communication lanes 108 are in an operation mode and a data frame (e.g., the data frame 208) is transmitted from the communication interface 110 at the first end 202 to the other communication interface 112 at the second end 204 of the communication link 106. Similarly, a data frame can be transmitted from the other communication interface 112 at the second end 204 to the communication interface 110 at the first end 202 of the communication link 106. Along with the data communication, the logic 206 at the communication interface 110 is configured to identify that the status of any communication lane of the number of communication lanes 108 has changed to a determined status (or a faulty status). After detection, the lane 1 is detected as a faulty lane. Thereafter, the logic 206 is configured to communicate the changed (i.e., faulty) status of the lane 1 to the other communication interface 112 at the second end 204. The information about the changed (i.e., faulty) status of the lane 1 is communicated to the communication interface 110 at the first end 202 as well as to the other communication interface 112 at the second end 204 of the communication link 106 by use of the “common message” field of OAM message. Therefore, each of the communication interface 110 and the other communication interface 112 agrees that there is a fault in the lane 1 and hence, the corresponding gate (e.g., G₁) is required to be shut down at each of the communication interface 110 and the other communication interface 112. Additionally, the MAC layer at each of the communication interface 110 and the other communication interface 112 is notified through MAC interface (e.g., MII interface) that the link capacity will be lowered for both directions. In the circuit architecture 300, the lane 1 is faulty, however, the remaining lanes, such as the lane 2, lane 3, . . . , lane N are still in operation. After communication of the faulty lane status of the lane 1 between both ends of the communication link 106, a number of subframes of a data frame (e.g., the data frame 208) received from the MAC layer at the communication interface 110 starts to enter each buffer of the number of buffers 216 starting from gate 2 (also represented as G₂) up to gate n (also represented as Gₙ) and this process is repeated again from the gate 2 (i.e., G₂). Indeed, the lane 1 is faulty, the transcoder 210 is configured to provide the number of subframes corresponding to the remaining buffers (i.e., T₂ₙ, . . . , Tₖₙ) that are still in operation. In the transcoder 210, the space that is correspond to the gate 1 (i.e., G₁) which is not functional currently, is filled with a dummy data and later on, the dummy data is ignored. This further leads correct decoding at a receiver (or the other communication interface 112). In this way, the physical layer at each of the communication interface 110 and the other communication interface 112 is configured to maintain the status of communication lanes and availability through the OAM message. Furthermore, as long as there is a fault in one lane, free communication takes place seamlessly between both ends (i.e., the first end 202 and the second end 204) of the communication link 106 with a partially reduced speed.

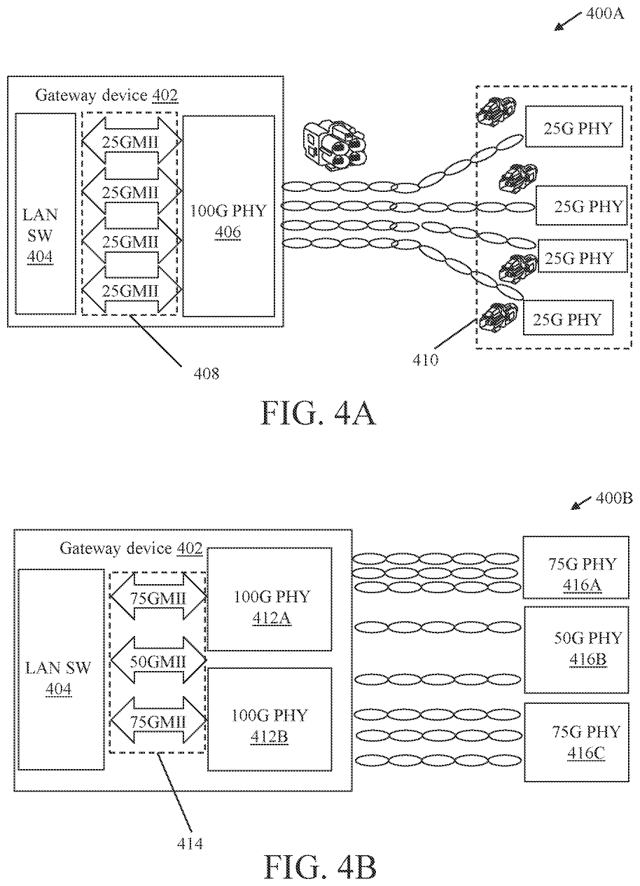

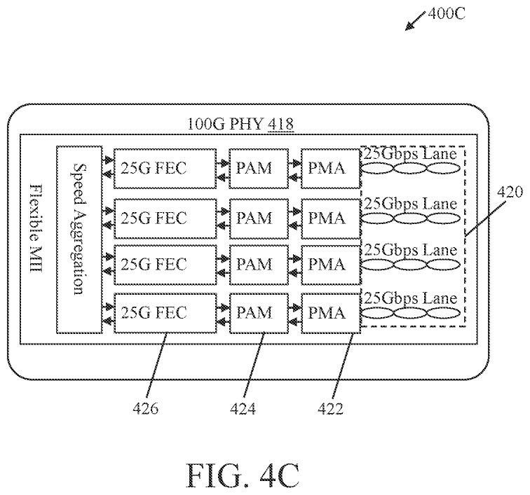

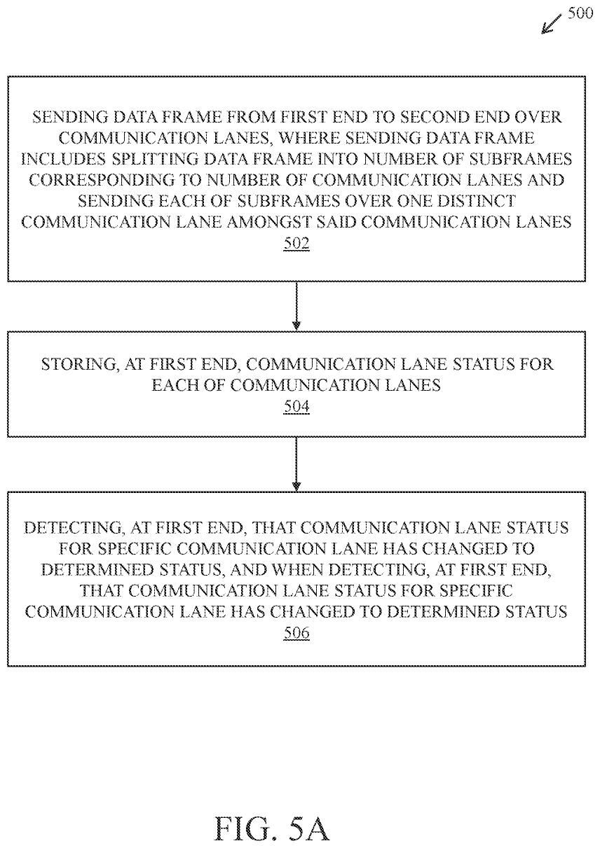

FIG. 4A illustrates merging of a number of communication lanes without a failure scenario, in accordance with an embodiment of the present disclosure. FIG. 4A is described in conjunction with elements from FIGS. 1, 2, and 3. With reference to FIG. 4A, there is shown an implementation scenario 400A that illustrates merging of a number of communication lanes without any failure. The implementation scenario 400A includes a gateway device 402 comprising a local area network switch (LAN SW) 404. The LAN SW 404 is connected to a physical layer 406 of 100 Gbit/s (also represented as 100 G PHY) through a number of communication lanes 408. The gateway device 402 is further connected to a plurality of sensors 410 via twisted pair cables and providing a bandwidth of 25 Gbit/s to each sensor.

The gateway device 402 includes suitable logic, circuitry, interfaces, or code that is configured to provide variable bandwidths depending on demand of a data traffic. The gateway device 402 may be an ethernet gateway device. Generally, a gateway device may be defined as a “gate” between two nodes of a communication network. The gateway device 402 corresponds to a hardware device, and examples of the gateway device 402 include, but are not limited to, a router, a firewall, a server, or any other hardware device that enables the flow of traffic in a communication network (e.g., the communication network 100) and out of the communication network.

The LAN SW 404 corresponds to one of the first node 102 and the second node 104 of the communication network 100 (of FIG. 1). The LAN SW 404 may also be referred to as an ethernet switch. Generally, a LAN SW may be defined as an internet protocol (IP)-based ethernet switch that flexibly connects a transmitter and a receiver through a communication network. The LAN SW is used to extend a local area network across different platforms, and it supports multiple simultaneous transmissions as well as reading of destination address of each data and forwarding the data to a target device.

The physical layer 406 of 100 Gbit/s can be a physical layer of either the communication interface 110 used at the first end 202 or the other communication interface 112 used at the second end 204 of the communication link 106.

Each of the number of communication lanes 408 is configured to connect the LAN SW 404 to the physical layer 406 of 100 Gbit/s via a MII interface. The number of communication lanes 408 includes four communication lanes which support full-duplex communication. The number of communication lanes 408 correspond to the number of communication lanes 108 comprised by the communication link 106 (of FIG. 1). Each of the number of communication lanes 408 carries 25 Gbit/s and with an operation mode status. Alternatively stated, none of the number of communication lanes 408 is faulty in the implementation scenario 400A. Thus, the gateway device 402 can provide variable bandwidths, such as 25 Gbit/s, 50 Gbit/s, 75 Gbit/s, or 100 Gbit/s to the plurality of sensors 410 by merging one or more of the number of communication lanes 408 into each other. The plurality of sensors 410 corresponds to one or more of the first sensor 114A, the second sensor 114B, the third sensor 114C and the fourth sensor 114D (of FIG. 1). For example, if there is a requirement of 75 Gbit/s bandwidth only, then a user can set the configuration (e.g., merging three communication lanes of the number of communication lanes 408) of the gateway device 402 accordingly and a specific lane of the number of communication lanes 408 can be disabled in order to reduce power and utilize a system performance as per demand of data traffic.

FIG. 4B illustrates merging of a number of communication lanes without a failure scenario, in accordance with another embodiment of the present disclosure. FIG. 4B is described in conjunction with elements from FIGS. 1, 2, 3, and 4A. With reference to FIG. 4B, there is shown an implementation scenario 400B that illustrates merging of a number of communication lanes without any failure. The implementation scenario 400B includes the gateway device 402 comprising the local area network switch (LAN SW) 404 (of FIG. 4A). The LAN SW 404 is connected to two physical layers, such as a first physical layer 412A of 100 Gbit/s (also represented as 100 G PHY) and a second physical layer 412B of 100 Gbit/s through a number of communication lanes 414. The gateway device 402 further provides variable bandwidths to different physical layers through twisted pair cables. The different physical layers include a first physical layer 416A of 75 Gbit/s, a second physical layer 416B 50 Gbit/s, and a third physical layer 416C of 75 Gbit/s.

In the implementation scenario 400B, the gateway device 402 uses two physical layers, such as the first physical layer 412A of 100 Gbit/s and the second physical layer 412B of 100 Gbit/s. The LAN SW 404 is connected to each of the first physical layer 412A of 100 Gbit/s and the second physical layer 412B of 100 Gbit/s through the number of communication lanes 414, and each communication lane has a different bandwidth. The number of communication lanes 414 includes three communication lanes, such as a first communication lane with a bandwidth of 75 Gbit/s, a second communication lane with a bandwidth of 50 Gbit/s, and a third communication lane with a bandwidth of 75 Gbit/s.

In the implementation scenario 400B, each of the first physical layer 412A of 100 Gbit/s and the second physical layer 412B of 100 Gbit/s can be grouped together to provide more combinations of speed grades at output of the gateway device 402. In this way, the gateway device 402 can support non-standard speed grades, such as 75 Gbps, 125 Gbps, and the like. Thus, the gateway device 402 can provide variable bandwidths to different physical layers such as the first physical layer 416A of 75 Gbit/s, the second physical layer 416B 50 Gbit/s, and the third physical layer 416C of 75 Gbit/s by grouping the first physical layer 412A of 100 Gbit/s and the second physical layer 412B of 100 Gbit/s. For example, three twisted-pair cables connected to the first physical layer 412A of 100 Gbit/s, each carrying 25 Gbit/s can provide the first physical layer 416A of 75 Gbit/s, one twisted pair cable connected to each of the first physical layer 412A of 100 Gbit/s and the second physical layer 412B of 100 Gbit/s can provide the second physical layer 416B 50 Gbit/s and three twisted-pair cables connected to the second physical layer 412B of 100 Gbit/s, each carrying 25 Gbit/s can provide the third physical layer 416C of 75 Gbit/s.

FIG. 4C illustrates an internal circuitry of a physical layer of 100 Gbit/s, in accordance with an embodiment of the present disclosure. FIG. 4C is described in conjunction with elements from FIGS. 1, 2, 3, 4A, and 4B. With reference to FIG. 4C, there is shown an internal circuit 400C of a physical layer 418. The physical layer 418 has a bandwidth of 100 Gbps (also represented as 100 G PHY). The physical layer 418 includes a number of communication lanes 420, a number of physical medium attachment (PMA) 422, a number of pulse amplitude modulators (PAM) 424, and a number of forward error correction (FEC) encoders-decoders 426.

The internal circuit 400C of the physical layer 418 is configured to use the number of FEC EN-DEC 426, each FEC EN-DEC with a bandwidth of 25 Gbps instead of one FEC EN-DEC of 100 Gbps. The number of communication lanes 420 correspond to the number of communication lanes 108 comprised by the communication link 106 (of FIG. 1). The number of PMA 422 may include transmitter/receiver-analog front end (TX/RX-AFE).

The internal circuit 400C of the physical layer 418 illustrates that data is received by the RX-AFE comprised by the number of PMA 422 over the number of communication lanes 420. Thereafter, the received data is modulated by use of the number of pulse amplitude modulators (PAM) 424 and then, encoded (or decoded) by the number of FEC EN-DEC 426. The use of the number of FEC EN-DEC 426 provides different speed aggregation to a flexible MII interface, configured for use between the physical layer 418 and a medium access control (MAC) layer (not shown here).

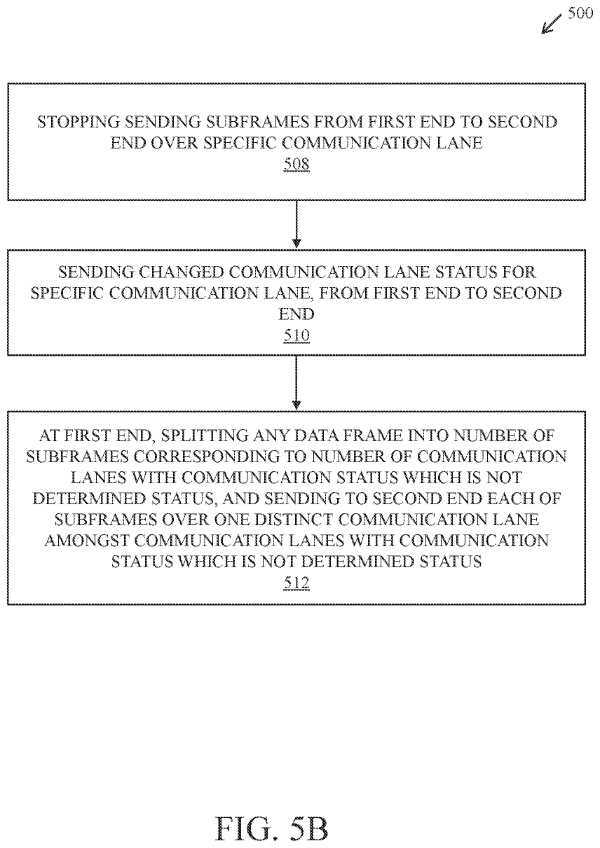

FIGS. 5A and 5B collectively is a flowchart of a method of communication over a communication link comprising a number of communication lanes, in accordance with an embodiment of the present disclosure. FIGS. 5A and 5B are described in conjunction with elements from FIGS. 1, 2, and 3. With reference to FIGS. 5A and 5B, there is shown a method 500 that illustrates a communication over a communication link comprising a number of communication lanes greater or equal to two and having a first end and a second end. The method 500 includes 502-to-512 steps (steps 502-506 of the method 500 are shown in FIG. 5A, and steps 508-512 are shown in FIG. 5B). The method 500 is executed by the communication interface 110 and the other communication interface 112 (of FIG. 1), described in detail, for example, in FIGS. 1, and 2.

The present disclosure provides the method 500 of communication over a communication link 106 comprising a number of communication lanes 108 greater or equal to two and having a first end 202 and a second end 204, the method 500 comprising sending a data frame 208 from the first end 202 to second end 204 over the communication lanes 108, wherein sending the data frame 208 includes splitting the data frame 208 into a number of subframes 218 corresponding to the number of communication lanes 108 and sending each of the subframes 218 over one distinct communication lane amongst said communication lanes 108, the method 500 further comprising:
storing, at the first end 202, a communication lane status for each of the communication lanes; and
detecting, at the first end 202, that the communication lane status for a specific communication lane has changed to a determined status, and when detecting, at the first end 202, that the communication lane status for the specific communication lane has changed to the determined status:
   stopping sending subframes from the first end 202 to the second end 204 over the specific communication lane;
   sending the changed communication lane status for the specific communication lane, from the first end 202 to the second end 204,
   at the first end 202, splitting any data frame into a number of subframes corresponding to the number of communication lanes 108 with a communication status which is not the determined status, and sending to the second end 204 each of the subframes over one distinct communication lane amongst the communication lanes with a communication status which is not the determined status.

The method 500 illustrates a communication over the communication link 106 comprising the number of communication lanes 108 greater or equal to two and having the first end 202 and the second end 204. Alternatively stated, the method 500 illustrates the communication between the first node 102 with the communication interface 110 and the second node 104 with the other communication interface 112 in the steps from 502-to-512.

With reference to FIG. 5A, at step 502, the method 500 comprises sending a data frame 208 from the first end 202 to second end 204 over the communication lanes 108, where sending the data frame 208 includes splitting the data frame 208 into a number of subframes 218 corresponding to the number of communication lanes 108 and sending each of the subframes 218 over one distinct communication lane amongst said communication lanes 108. The data frame 208 is received from a medium access control (MAC) layer by a physical layer of the first end 202 of the communication link 106. Thereafter, the data frame 208 is split into the number of subframes 218 corresponding to the number of communication lanes 108. Each of the number of subframes 218 is sent to the second end 204 through one distinct communication lane among the number of communication lanes 108.

At step 504, the method 500 further comprises storing, at the first end 202, a communication lane status for each of the communication lanes. The logic 206 at the communication interface 110 is configured to store the status of each of the number of communication lanes 108.

At step 506, the method 500 further comprises detecting, at the first end 202, that the communication lane status for a specific communication lane has changed to a determined status, and when detecting, at the first end 202, that the communication lane status for the specific communication lane has changed to the determined status. The logic 206 of the communication interface 110 at the first end 202 is further configured to detect that if the communication lane status (either faulty or working) of any communication lane of the number of communication lanes 108 has changed to the determined status (i.e., a faulty status).

Now referring to FIG. 5B, at step 508, the method 500 further comprises stopping sending subframes from the first end 202 to the second end 204 over the specific communication lane. After detecting that the communication lane status of the specific communication lane has changed to the determined status, the logic 206 is further configured to stop sending the subframes over that specific communication lane from the first end 202 to the second end 204.

At step 510, the method 500 further comprises sending the changed communication lane status for the specific communication lane, from the first end 202 to the second end 204. The logic 206 is further configured to communicate the changed communication lane status (i.e., faulty) of the specific communication lane to the other communication interface 112 at the second end 204 of the communication link 106.

At step 512, the method 500 further comprises at the first end 202, splitting any data frame into a number of subframes corresponding to the number of communication lanes 108 with a communication status which is not the determined status, and sending to the second end 204 each of the subframes over one distinct communication lane amongst the communication lanes with a communication status which is not the determined status. The logic 206 is further configured to split the data frame into the number of subframes corresponding to the number of communication lanes 108, which are active at that time. The logic 206 is further configured to send each of the subframes over one distinct communication lane among the number of communication lanes 108, which are active at that time.

In accordance with an embodiment, the method 500 further comprises for each communication lane, inputting, in a buffer at the first end 202, a subframe to be transmitted, over the said communication lane, to a corresponding buffer at the second end 204, and controlling a gate at the first end 202 to open or close the input in the buffer of a subframe to be transmitted over the said communication lane, to the corresponding buffer at the second end 204, depending on the communication lane status of said communication lane. After dividing the data frame 208 into the number of subframes 218, each subframe is passed to the buffer comprised by the communication interface 110. Each buffer of the number of buffers 216 is configured to transmit the received subframe over one communication lane to the corresponding buffer comprised by the communication interface 112 at the second end 204 of the communication link 106. In addition to the number of buffers 216, the communication interface 110 comprises the number of gates 214. Each of the number of gates 214 is configured to open or close the input in the buffer of the subframe which is to be transmitted over one communication lane of the number of communication lanes 108.

In accordance with an embodiment, the method 500 further comprises receiving at the first end 202 a data frame from the second end 204 over the communication lanes (or the number of communication lanes 108), a received data frame being split into a number of received subframes corresponding to the number of communication lanes 108, where receiving the data frame includes receiving each of the subframes over one distinct communication lane amongst said communication lanes and merging the received subframes into a received data frame. In an implementation, the communication interface 110 at the first end 202 can be configured to function as a receiver, and the other communication interface 112 at the second end 204 can be configured to function as a transmitter. In such implementation, the logic 206 at the first end 202 is configured to receive the data frame from the second end 204 over the number of communication lanes 108. Indeed, the received data frame being split into the number of received subframes (e.g., F1, F2, F3, . . . , Fn) proportional to the number of communication lanes 108, the logic 206 is configured to receive each of the subframes over one distinct communication lane amongst said communication lanes and merging the received subframes into the received data frame.

The method 500 further comprises receiving, at the first end 202, the determined status as the communication lane status of a given communication lane from the second end 204, and store the received determined status as the status of the given communication lane. The method 500 further comprises stop receiving, at the first end 202, subframes over the given communication lane from the second end 204 and merging, at the first end 202, the subframes received over the communication lanes with a communication status which is not the determined status, into the received data frame. In order to receive each subframe, the logic 206 is further configured to receive the determined (i.e., faulty) status, if any, of the given communication lane from the other communication interface 112 at the second end 204 and store the received determined status as the communication status of the given communication lane. In case of the faulty communication lane, the logic 206 is further configured to stop receiving the subframes over the faulty communication lane and merge the subframes received over the healthy communication lanes in order to obtain the received data frame.

In accordance with an embodiment, the method 500 further comprises outputting, in the buffer at the first end 202, a subframe received over the communication lane from the corresponding buffer at the second end 204, and controlling the gate at the first end 202 to open or close the output of the received subframe over the said communication lane, depending on the communication lane status of said communication lane. Each buffer of the number of buffers 216 is configured to receive the subframe which is transmitted by the corresponding buffer in communication interface 112 at the second end 204 of the communication link 106. Consequently, each gate of the number of gates 214 is configured to open or close the output of the subframe received over the communication lane among the number of communication lanes 108. The logic 206 is further configured to control each of the number of gates 214 depending on the status (either functional or non-functional) status of the number of communication lanes 108.

In accordance with an embodiment, the present disclosure provides a computer program product comprising program code for performing the method 500 when executed by a processor (or the logic 206) in a computer system. The logic 206 of the communication interface 110 is configured to execute the method 500.

Thus, the method 500 provides seamless data communication between the first node 102 and the second node 104 of the communication network 100, even in case of a lane failure. If any fault is detected in any one lane of the number of communication lanes 108, the method 500 immediately communicates the lane failure to each of the communication interface 110 and the other communication interface 112 and stop sending the number of subframes 218 of the data frame 208 over the faulty lane. Thus, the method 500 provides safety regarding the lane failure as well as seamless data communication between both ends of the communication link 106 at a partially reduced speed.

The steps 502-to-512 are only illustrative, and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

What is claimed is:

1. A communication interface (110) for use at a first end (202) of a communication link (106) comprising a number of communication lanes (108) greater or equal to two, the communication interface (110) comprising a logic (206) configured to cooperate with another communication interface (112) at a second end (204) of the communication link (106) to send a data frame (208) to the second end (204) over the communication lanes (108), wherein sending a data frame (208) includes splitting the data frame (208) into a number of subframes (218) corresponding to the number of communication lanes (108) and sending each of the subframes over one distinct communication lane amongst said communication lanes (108), the logic (206) being further configured to:
store a communication lane status for each of the communication lanes (108); and when detecting that the communication lane status for a specific communication lane has changed to a determined status:
stop sending subframes over the specific communication lane;
send the changed communication lane status for the specific communication lane to the communication interface (112) at the second end (204),
split any data frame into a number of subframes corresponding to the number of communication lanes (108) with a communication status which is not the determined status, and send each of the subframes over one distinct communication lane amongst the communication lanes with a communication status which is not the determined status.

2. The communication interface (110) according to claim 1, the logic (206) being further configured to cooperate with the communication interface (112) at the second end (204) of the communication link (106) to receive a data frame from the second end (204) over the communication lanes (108), a received data frame being split into a number of received subframes corresponding to the number of communication lanes (108), wherein receiving the data frame includes receiving each of the subframes over one distinct communication lane amongst said communication lanes (108) and merging the received subframes into a received data frame, and wherein the logic (206) is further configured to:
receive the determined status as the communication lane status of a given communication lane from the communication interface (112) at the second end (204), and store the received determined status as the status of the given communication lane;
stop receiving subframes over the given communication lane;
merge the subframes received over the communication lanes with a communication status which is not the determined status, into the received data frame.

3. The communication interface (110) according to claim 1, further comprising, for each communication lane, a buffer configured to receive a subframe to be transmitted, over the said communication lane, to a corresponding buffer in the communication interface (112) at the second end (204), and a gate configured to open or close the input in the buffer of a subframe to be transmitted over the said communication lane, to the corresponding buffer in the communication interface (112) at the second end (204), the logic (206) being configured to control the gate depending on the communication lane status of said communication lane.

4. The communication interface (110) according to claim 3, wherein the buffer is configured to receive a subframe transmitted over the communication lane from the corresponding buffer in the communication interface (112) at the second end (204), and the gate is configured to open or close the output of a subframe received over the said communication lane, the logic (206) being configured to control the gate depending on the communication lane status of said communication lane.

5. A communication network (100) comprising a first node (102) at a first end (202) of a communication link (106) and second node (104) at a second end (204) of the communication link (106), said communication link (106) comprising a number of communication lanes (108) greater or equal to two, the first node (102) and the second node (104) each comprising the communication interface (110) according to claim 1.

6. The communication network (100) according to claim 5, said communication network (100) being an in-vehicle communication network.

7. A method (500) of communication over a communication link (106) comprising a number of communication lanes (108) greater or equal to two and having a first end (202) and a second end (204), the method (500) comprising sending a data frame (208) from the first end (202) to the second end (204) over the communication lanes (108), wherein sending a data frame (208) includes splitting the data frame (208) into a number of subframes (218) corresponding to the number of communication lanes (108) and sending each of the subframes over one distinct communication lane amongst said communication lanes (108), the method (500) further comprising:
storing, at the first end (202), a communication lane status for each of the communication lanes (108); and
detecting, at the first end (202), that the communication lane status for a specific communication lane has changed to a determined status, and when detecting, at the first end (202), that the communication lane status for the specific communication lane has changed to the determined status:
stopping sending subframes from the first end (202) to the second end (204) over the specific communication lane;
sending the changed communication lane status for the specific communication lane, from the first end (202) to the second end (204),
at the first end (202), splitting any data frame into a number of subframes corresponding to the number of communication lanes with a communication status which is not the determined status, and sending to the second end (204) each of the subframes over one distinct communication lane amongst the communication lanes with a communication status which is not the determined status.

8. The method (500) according to claim 7, further comprising receiving at the first end (202) a data frame from the second end (204) over the communication lanes (108), a received data frame being split into a number of received subframes corresponding to the number of communication lanes (108), wherein receiving the data frame includes receiving each of the subframes over one distinct communication lane amongst said communication lanes and merging the received subframes into a received data frame, and the method (500) further comprising:
receiving, at the first end (202), the determined status as the communication lane status of a given communication lane from the second end (204), and store the received determined status as the status of the given communication lane;
stop receiving, at the first end (202), subframes over the given communication lane from the second end (204);
merging, at the first end (202), the subframes received over the communication lanes with a communication status which is not the determined status, into the received data frame.

9. The method (500) according to claim 7, further comprising, for each communication lane, inputting, in a buffer at the first end (202), a subframe to be transmitted, over the said communication lane, to a corresponding buffer at the second end (204), and controlling a gate at the first end (202) to open or close the input in the buffer of a subframe to be transmitted over the said communication lane, to the corresponding buffer at the second end (204), depending on the communication lane status of said communication lane.

10. The method (500) according to claim 9, further comprising outputting, in the buffer at the first end (202), a subframe received over the communication lane from the corresponding buffer at the second end (204), and controlling the gate at the first end (202) to open or close the output of the received subframe over the said communication lane, depending on the communication lane status of said communication lane.

11. A computer program product comprising program code for performing the method (500) according to claim 7, when executed by a processor in a computer system.
